(19) United States
(12) Patent Application Publication
(10) Pub. No.: US 2025/0247033 A1
(43) Pub. Date: Jul. 31, 2025

(54) MOTOR DRIVE CONTROL DEVICE, MOTOR UNIT, AND MOTOR DRIVE CONTROL METHOD

(71) Applicant: MINEBEA MITSUMI Inc., Kitasaku-gun (JP)

(72) Inventor: Daisuke SHIMIZU, Kitasaku-gun (JP)

(21) Appl. No.: 19/036,174

(22) Filed: Jan. 24, 2025

(30) Foreign Application Priority Data
Jan. 31, 2024 (JP) 2024-013192

(51) Int. Cl. H02P 23/20

(52) U.S. Cl. CPC H02P 23/20

(57) ABSTRACT

A motor drive control device includes a drive circuit for driving a motor based on a drive control signal, and a control circuit for calculating an operation amount of the motor so that the motor rotates at a target rotation speed based on a drive command signal specifying a target rotation speed and generates and outputs a drive control signal corresponding to the operation amount. The control circuit sets a change rate of an operation amount to be smaller the closer the operation amount to a target operation amount corresponding to the target rotation speed when decelerating the motor according to a change in the target rotation speed, and the control circuit changes the operation amount in accordance with the change rate so that the operation amount coincides with the target operation amount after change when decelerating the motor according to a change in the target rotation speed.

### CROSS-REFERENCE TO RELATED APPLICATIONS

This application claims the benefit of priority to Japanese Patent Application Number 2024-013192 filed on Jan. 31, 2024. The entire contents of the above-identified application are hereby incorporated by reference.

### TECHNICAL FIELD

The present invention relates to a motor drive control device, a motor unit, and a motor drive control method.

### BACKGROUND ART

In general, as a control method for a motor, speed control is known. In the speed control, the motor is controlled to rotate at a target rotation speed (see, for example, Patent Literature 1). In the speed control, a rotation speed of the motor desirably reaches the target rotation speed in a shorter time. For example, in a case where the motor is used as a driving source of a rotor blade (propeller) in a flight device such as a drone, it is necessary to change the target rotation speed when an aircraft body of the flight device is rapidly turned so that the rotation speed of the motor quickly reaches the target rotation speed.

### CITATION LIST

### Patent Literature

Patent Literature 1: JP 2846332 B

### SUMMARY OF INVENTION

### Technical Problem

The inventor of the present application has found the following problems in a motor drive control method for a motor for rotating a propeller at a flight device such as a drone.

A motor drive control device for performing drive control of the motor for the flight device controls the motor so that the motor (rotor) rotates at a target rotation speed by calculating an operation amount in accordance with a target rotation speed, generating a drive control signal (PWM signal) having a duty ratio corresponding to the operation amount, and driving an inverter circuit. Here, the operation amount of the motor is the duty ratio of the drive control signal (PWM signal) for driving the inverter circuit, and is a value corresponding to a magnitude of a power (current) to be supplied to the motor. The motor is controlled so that the motor (rotor) rotates at the target rotation speed by changing the duty ratio.

For example, when decelerating the aircraft body of the flight device, the motor drive control device reduces the duty ratio of the drive control signal by reducing the operation amount to a target operation amount corresponding to the target rotation speed at a predetermined change rate. As a result, the rotation speed of the motor decreases, and the flight device can be decelerated.

However, at the time of deceleration, the centrifugal force of the propeller coupled at the motor increases the load of the motor, so that the change in the rotation speed of the motor becomes gentle with respect to the change in the duty ratio of the drive control signal. As a result, the time required for the rotation speed of the motor to reach the target rotation speed becomes longer. In other words, a speed response of the motor decreases at the time of deceleration.

Thus, the inventor of the present application has studied to increase the speed response of the motor by increasing the change rate of the operation amount (duty ratio of the drive control signal) of the motor at the time of deceleration of the flight device.

However, when the change rate of the operation amount at the time of deceleration of the motor is increased, the duty ratio of the drive control signal is set to a value lower than a value suitable for the rotation speed of the motor at that time. As a result, problems are generation of a great counter electromotive force at the motor and an increase in the voltage (power supply voltage) of the power supply line connected to the inverter circuit for driving the motor.

FIG. 7 is a diagram showing a temporal change of the power supply voltage at the time of deceleration of the motor when the motor is driven by a motor drive control method according to a prior study example by the present inventor.

In FIG. 7, the horizontal axis represents time [sec], and the vertical axis represents a voltage (power supply voltage) [V] of the power supply line connected to the inverter circuit for driving the motor. Reference numeral 800 represents a simulation result of the power supply voltage with respect to time when the motor is decelerated with the change rate of the operation amount (duty ratio) of the motor fixed to a great value.

As shown in FIG. 7, it is understood that when the motor is driven with the power supply voltage set to 40 V at the normal time and the motor is rapidly decelerated at 1 [sec], the power supply voltage increases to about 65 V. This phenomenon is considered to be caused by a fact. In the fact, a great counter electromotive force is generated at a coil of the motor due to a steep decrease in the operation amount of the motor, i.e., the duty ratio of the drive control signal at the time of deceleration, and the counter electromotive force is regenerated at the power supply line.

As described above, when the change rate of the operation amount (duty ratio) of the motor at the time of deceleration of the motor is simply increased, the power supply voltage increases. As a result, the drive control of the motor becomes unstable, and electronic components and the like constituting the motor drive control device may break down.

The present invention is to solve the problems described above, and an object of the present invention is to improve the speed response of the motor while suppressing an increase in the power supply voltage at the time of deceleration of the motor.

### Solution to Problem

A motor drive control device according to a representative embodiment of the present invention includes a drive circuit for driving a motor based on a drive control signal for controlling driving of the motor, and a control circuit for calculating an operation amount of the motor so as to rotate the motor at the target rotation speed based on a drive command signal specifying a target rotation speed of the motor, and generate and output the drive control signal in accordance with the operation amount, in which the control circuit sets a change rate of the operation amount to be smaller the closer the operation amount to a target operation amount corresponding to the target rotation speed when decelerating the motor according to a change in the target rotation speed, and the control circuit changes the operation amount in accordance with the change rate so that the operation amount coincides with the target operation amount after change when decelerating the motor according to a change in the target rotation speed.

### Advantageous Effects of Invention

According to an aspect of the present invention, it is possible to improve a speed response of a motor while suppressing an increase in a power supply voltage at the time of deceleration of the motor.

### BRIEF DESCRIPTION OF DRAWINGS

FIG. 1 is a diagram illustrating a configuration of a motor unit including a motor drive control device according to an embodiment.

FIG. 2 is a diagram illustrating an example of a functional block configuration of a control circuit.

FIG. 3 is a diagram showing an overview of a control method for an operation amount of a motor by the motor drive control device according to the embodiment.

FIG. 4 is a diagram for describing a method of setting a change rate of an operation amount by the motor drive control device according to the embodiment.

FIG. 5 is a flowchart illustrating a sequence of processing for the method of setting the change rate of the operation amount by the motor drive control device according to the embodiment.

FIG. 6A is a diagram showing a temporal change of a rotation speed at the time of deceleration of the motor at the motor unit according to the embodiment.

FIG. 6B is a diagram showing a temporal change of a power supply voltage at the time of deceleration of the motor at the motor unit according to the embodiment.

FIG. 7 is a diagram showing a temporal change of a power supply voltage at the time of deceleration of the motor when the motor is driven by a motor drive control method according to a prior study example by the present inventor.

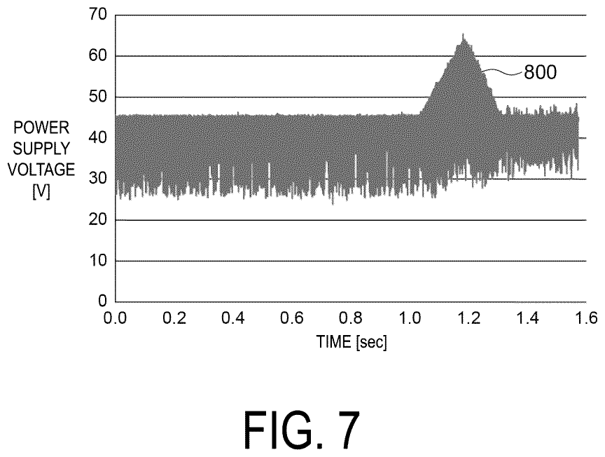

### DESCRIPTION OF EMBODIMENTS

### 1. Overview of Embodiments

First, a representative embodiment of the invention disclosed in the present application will be overviewed. In the following description, reference signs in the drawings corresponding to the components of the invention will be given in parentheses as an example.

[1] A motor drive control device (2) according to a representative embodiment of the present invention includes a drive circuit (6) for driving a motor (3) based on a drive control signal (Sd) for controlling driving of the motor, and a control circuit (5) for calculating an operation amount (Md) of the motor so as to rotate the motor at the target rotation speed based on a drive command signal (Sc) specifying a target rotation speed of the motor, and generate and output the drive control signal in accordance with the operation amount, in which the control circuit sets a change rate (Rv) of the operation amount to be smaller the closer the operation amount to a target operation amount (Mtg) corresponding to the target rotation speed when decelerating the motor according to a change in the target rotation speed, and the control circuit changes the operation amount in accordance with the change rate so that the operation amount coincides with the target operation amount after change when decelerating the motor according to a change in the target rotation speed.

[2] In the motor drive control device according to [1], when decelerating the motor according to a change in the target rotation speed, the control circuit may divide an operation amount adjustment range (Wm) into a plurality of sections (S1 to S(n+1)), the operation amount adjustment range (Wm) being a range from the operation amount before the target operation amount is changed to the target operation amount after change, and assign a plurality of the change rates different from each other respectively to the sections such that the change rate is smaller the closer the sections to the target operation amount. [3] In the motor drive control device according to [2], the control circuit may divide the operation amount adjustment range into the plurality of sections by equally dividing the operation amount adjustment range.

[4] In the motor drive control device according to [2], the control circuit may divide the operation amount adjustment range into the plurality of sections by dividing the operation amount adjustment range at ratios different from each other.

[5] In the motor drive control device according to [2], the control circuit may include a target operation amount calculation unit (11) for calculating the target operation amount based on the drive command signal, an operation amount calculation unit (15) for calculating the operation amount by changing the operation amount in accordance with the change rate so as to reach the target operation amount, a drive control signal generation unit (17) for generating a PWM signal having a duty ratio corresponding to the operation amount and outputting the PWM signal as the drive control signal, a deceleration determination unit (12) for determining whether to decelerate the motor based on a difference between the target operation amount and the operation amount when the target operation amount is changed, a reference point setting unit (13) for setting a reference point within the operation amount adjustment range when the deceleration determination unit determines to decelerate the motor, a storage unit (16) for storing change rate information (Gd1 to Gd(n+1)) including a plurality of values different from each other and settable as the plurality of change rates, and a change rate setting unit (14) for dividing the operation amount adjustment range into the plurality of sections with the reference point as a boundary and setting the change rate for each of the sections, in which the change rate setting unit may set the change rate for each of the sections such that the change rate is smaller the closer the section to the target operation amount based on the change rate information, and the operation amount calculation unit may specify the section, with an immediately preceding operation amount belonging to the section specified, and change the operation amount to the target operation amount based on the change rate set in the specified section.

[6] In the motor drive control device according to [5], the storage unit may store a reference point calculation condition (20) specifying a ratio of dividing the operation amount adjustment range, and the reference point setting unit may set a point, as the reference point, dividing the operation amount adjustment range at a ratio specified by the reference point calculation condition.

[7] A motor unit (1) according to a representative embodiment of the present invention, includes the motor drive control device (2) according to any one of above [1] to [6], and the motor.

[8] A motor control method according to a representative embodiment of the present invention includes a first step of calculating an operation amount of a motor to rotate the motor at a target rotation speed, and a second step of generating a drive control signal in accordance with the operation amount calculated in the first step to drive the motor, in which the first step includes a third step (steps St1 to St8) of setting a change rate of the operation amount to be smaller the closer the operation amount to a target operation amount corresponding to the target rotation speed when decelerating the motor according to a change in the target rotation speed, and a fourth step of changing the operation amount based on the change rate so that the operation amount coincides with the target operation amount after change when decelerating the motor according to a change in the target rotation speed.

### 2. Specific Examples of Embodiments

Specific examples of embodiments of the present invention will be described below with reference to the drawings. In the following description, the same reference signs are used for common components in the respective embodiments, and repeated descriptions will be omitted.

### Embodiments

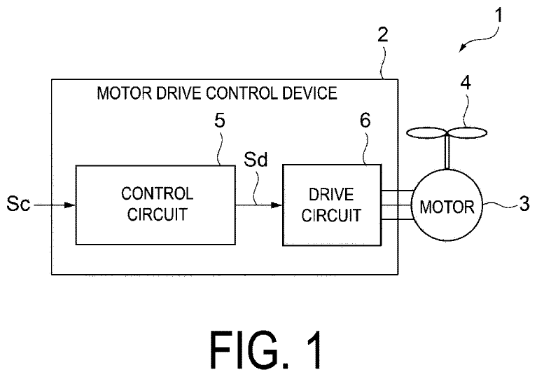

FIG. 1 is a diagram illustrating a configuration of a motor unit 1 including a motor drive control device 2 according to an embodiment.

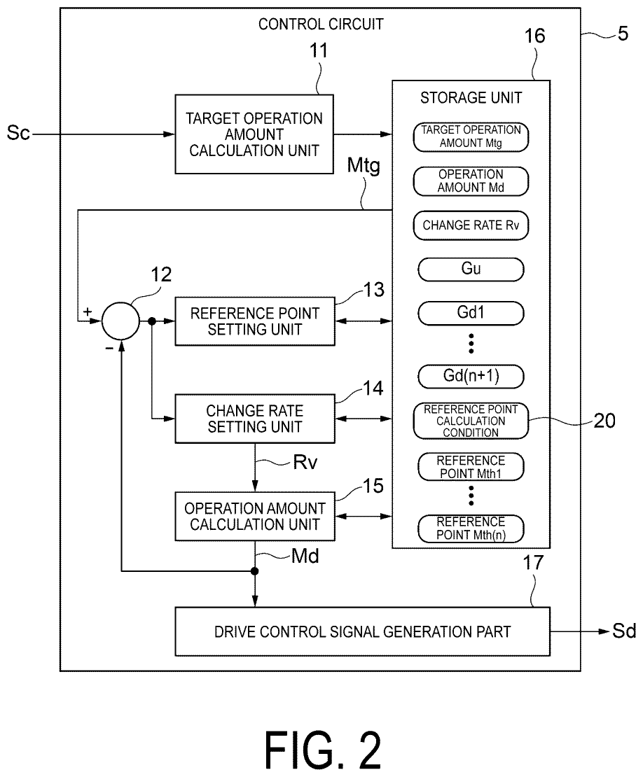

FIG. 2 is a diagram illustrating an example of a functional block configuration of a control circuit 5.

The motor unit 1 illustrated in FIG. 1 is mounted at, for example, a flight device such as a drone, and can be applied as a driving source of a rotor blade (propeller) of the flight device. The motor unit 1 includes, for example, a motor 3 and the motor drive control device 2.

The motor 3 includes at least one coil. The motor 3 is, for example, a brushless DC motor including coils (windings) of three phases (U-phase, V-phase, and W-phase). For example, the rotor blade 4 is coupled at an output shaft of the motor 3 via a decelerator (not illustrated) or the like.

The motor unit 1 may include a position detection device such as a hall element. The position detection device detects a magnetic pole of a rotor (not illustrated) of the motor 3 and outputs a position detection signal having a voltage changing in accordance with rotation of the rotor.

The motor drive control device 2 controls the drive of the motor 3. For example, the motor drive control device 2 controls the driving of the motor 3 so that the motor 3 rotates at a target rotation speed specified by a drive command signal Sc.

Specifically, the motor drive control device 2 includes a control circuit 5 and a drive circuit 6.

The drive circuit 6 is a circuit for driving the motor 3 based on a drive control signal Sd output from the control circuit 5. The drive control signal Sd is a signal for controlling driving of the motor 3 and is, for example, a Pulse Width Modulation (PWM) signal.

The drive circuit 6 is, for example, an inverter circuit (for example, H bridge circuit) including a plurality of transistors as switch elements. The drive circuit 6 switches a direction of the motor current to rotate the motor 3 by switching the connection destination of the coil of the motor 3 between the direct current voltage and the ground potential in accordance with the PWM signal serving as the drive control signal Sd.

Note that the drive circuit 6 may include a pre-drive circuit for driving the transistors constituting the inverter circuit described above based on the drive control signal Sd. A sense resistor for detecting the current flowing at the motor may be connected to the inverter circuit.

The control circuit 5 is a circuit for comprehensively controlling the operation of the motor drive control device 2. In the present embodiment, the control circuit 5 is a program processing device having a configuration. In the configuration, a processor such as a CPU, various storage devices such as a RAM, a ROM, and a flash memory, and peripheral circuits such as a counter (timer), an A/D conversion circuit, a D/A conversion circuit, a clock generation circuit, and an input/output interface circuit are connected to each other via a bus or a dedicated line. For example, the control circuit 5 is a micro controller unit (MCU).

Note that the control circuit 5 and the drive circuit 6 may be packaged as one semiconductor integrated circuit (IC), or may be packaged as individual integrated circuit devices, mounted at a circuit board, and electrically connected to each other at the circuit board.

The control circuit 5 has a function of calculating an operation amount Md of the motor 3 so that the motor 3 rotates at a target rotation speed based on the drive command signal Sc specifying the target rotation speed of the motor 3, and generating and outputting a drive control signal Sd in accordance with the operation amount Md. Specifically, the control circuit 5 rotates the motor 3 at the target rotation speed by calculating an operation amount (hereinafter, also referred to as a “target operation amount”) Mtg of the motor 3 corresponding to the target rotation speed, generating a PWM signal having a duty ratio corresponding to the target operation amount Mtg, and outputting the PWM signal as the drive control signal Sd, by, for example, open loop control. When decelerating the motor 3 according to a change in the target rotation speed, the control circuit 5 changes the operation amount Md so that the operation amount Md coincides with the target operation amount Mtg corresponding to the target rotation speed after change.

Further, when decelerating the motor 3, the control circuit 5 has a function of switching a change rate Rv of the operation amount of the motor 3. Here, the change rate Rv of the operation amount is a change amount of the operation amount per unit time or unit control cycle, and is, for example, a change amount of a duty ratio for each cycle (PWM cycle) of the PWM signal as the drive control signal Sd.

Hereinafter, an overview of a method of switching the change rate Rv of the operation amount by the control circuit 5 will be described with reference to the drawings.

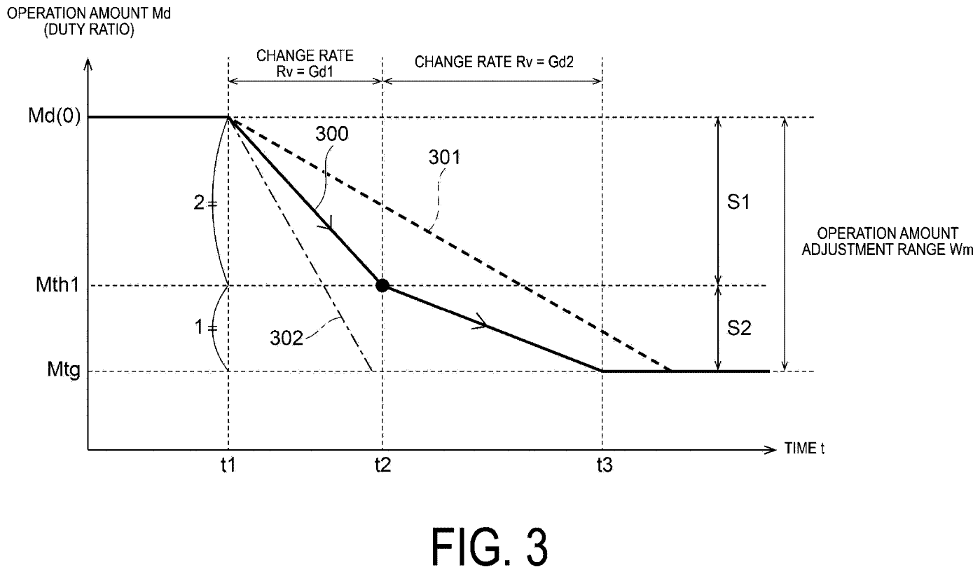

FIG. 3 is a diagram for describing a control method for the operation amount of the motor 3 by the motor drive control device 2 according to the embodiment.

In FIG. 3, the vertical axis represents the operation amount Md of the motor 3, and the horizontal axis represents time t. Reference numeral 300 represents a graph of the operation amount Md with respect to time when the operation amount Md is changed by the motor drive control method according to the present embodiment, and reference numerals 301 and 302 represent graphs of the operation amount Md with respect to time when the operation amount Md is changed at a constant change rate as a comparative example of the motor drive control method according to the present embodiment.

When decelerating the motor 3 according to a change in the target rotation speed, the control circuit 5 sets the change rate Rv of the operation amount Md to be smaller the closer the operation amount Md to the target operation amount Mtg. Specifically, when decelerating the motor 3 according to a change in the target rotation speed, the control circuit 5 divides an operation amount adjustment range Wm into a plurality of sections S1 to S(n+1) (n is an integer of 1 or more), the operation amount adjustment range Wm being a range from an operation amount Md(0) before the target operation amount Mtg is changed to the target operation amount Mtg after change, and assigns change rates Rv different from each other respectively to the sections S1 to S(n+1) such that the change rate Rv is smaller the closer the sections S1 to S(n+1) the target operation amount Mtg.

For example, as shown in FIG. 3, a case is considered. In the case, the operation amount Md is changed from the operation amount Md(0) before the target operation amount Mtg is changed to the target operation amount Mtg after change in order to decelerate the motor 3.

In this case, first, the control circuit 5 divides the operation amount adjustment range Wm from the operation amount Md(0) to the target operation amount Mtg into the plurality of sections S1 to S(n+1). In FIG. 3, a case is shown as an example. In the case, the operation amount adjustment range Wm is divided into two sections S1 and S2 with reference to a reference point Mth1.

Next, the control circuit 5 assigns change rates Rv different from each other respectively to the sections S1 and S2 such that the change rate Rv (the change rate of the operation amount with respect to time) is smaller the closer the sections S1 and S2 to the target operation amount Mtg. For example, when Gd1>Gd2, the control circuit 5 sets “Gd1” as the change rate Rv of the section S1 from the operation amount Md(0) before change to the reference point Mth1, and sets “Gd2” as the change rate Rv of the section S2 from the reference point Mth1 to the target operation amount Mtg after change.

Then, the control circuit 5 changes the operation amount Md in accordance with the change rate Rv so that the operation amount Md coincides with the target operation amount Mtg corresponding to the target rotation speed after change. For example, as shown in FIG. 3, the control circuit 5 changes the operation amount Md from the operation amount Md(0) before the target operation amount Mtg is changed to the target operation amount Mtg after change along the graph indicated by the reference numeral 300.

A specific configuration of the control circuit 5 for achieving the above functions will be described in detail below.

As illustrated in FIG. 2, the control circuit 5 includes, as functional blocks for achieving the above-described functions, a target operation amount calculation unit 11, a deceleration determination unit 12, a reference point setting unit 13, a change rate setting unit 14, an operation amount calculation unit 15, a storage unit 16, and a drive control signal generation unit 17 for example.

The above-described functional units of the control circuit 5 are achieved by program processing of the MCU serving as the control circuit 5. Specifically, the above-described functional units are achieved when the processor making up the MCU serving as the control circuit 5 performs various computations in accordance with the program stored at the memory to control each peripheral circuit making up the MCU.

The target operation amount calculation unit 11 is a functional unit for calculating a target operation amount Mtg based on the drive command signal Sc. Here, the drive command signal Sc is a signal including information instructing an operation state of the motor 3, for example, a signal including information specifying the target rotation speed of the motor 3. The drive command signal Sc may be, for example, a serial signal or a PWM signal having a duty ratio corresponding to the target rotation speed.

When the drive command signal Sc is input at the control circuit 5, the target operation amount calculation unit 11 acquires information on the target rotation speed included at the drive command signal Sc. The target operation amount calculation unit 11 calculates the target operation amount Mtg serving as an operation amount of the motor 3 corresponding to the target rotation speed.

For example, correspondence relationship information such as a table or a function indicating a correspondence relationship between the target rotation speed and the target operation amount Mtg is stored at the storage unit 16 in advance. The target operation amount Mtg and the operation amount Md may be values indicating the duty ratio of the PWM signal as the drive control signal Sd. For example, the target operation amount Mtg is set to increase as the target rotation speed increases. Thus, the duty ratio of the drive control signal Sd increases as the target rotation speed increases.

The target operation amount calculation unit 11 calculates the target operation amount Mtg corresponding to the target rotation speed acquired from the drive command signal Sc by referring to the correspondence relationship information stored at the storage unit 16. The target operation amount Mtg is stored at the storage unit 16.

The storage unit 16 is a functional unit for storing various types of data necessary for the control circuit 5 to achieve the function. The storage unit 16 stores, for example, the operation amount Md, the change rate Rv, a plurality of values Gd1 to Gd(n+1) different from each other and settable as the change rates Rv, a reference point calculation condition 20, and reference points Mth1 to Mth(n), described later, in addition to the correspondence relationship information indicating the correspondence relationship between the target rotation speed and the target operation amount Mtg and the target operation amount Mtg, described above.

The operation amount calculation unit 15 is a functional unit for calculating the operation amount Md of the motor 3. The operation amount calculation unit 15 calculates and outputs the operation amount Md so that the operation amount Md coincides with the target operation amount Mtg, and stores the operation amount Md at the storage unit 16. Specifically, as shown in FIG. 3, the operation amount calculation unit 15 changes the operation amount Md to the target operation amount Mtg in accordance with the change rate Rv set for each of the sections S1 to S(n+1) from the operation amount Md(0) before the target operation amount Mtg is changed to the target operation amount Mtg after change.

The drive control signal generation unit 17 is a functional unit for generating the drive control signal Sd. The drive control signal generation unit 17 generates the PWM signal having the duty ratio corresponding to the operation amount Md calculated by the operation amount calculation unit 15 and outputs the PWM signal as the drive control signal Sd. For example, when the operation amount Md represents the duty ratio, the drive control signal generation unit 17 outputs the PWM signal having the duty ratio specified by the operation amount Md, as the drive control signal Sd.

The deceleration determination unit 12 is a functional unit for determining whether to decelerate the rotation speed of the motor 3. When the target operation amount Mtg is changed, the deceleration determination unit 12 determines whether to decelerate the motor 3 based on a difference between the target operation amount Mtg and the operation amount Md. For example, when a value (Mtg−Md) obtained by subtracting the operation amount Md from the target operation amount Mtg is negative (Mtg<Md), the deceleration determination unit 12 determines to decelerate the motor 3. On the other hand, when the value (Mtg−Md) obtained by subtracting the operation amount Md from the target operation amount Mtg is positive (Mtg>Md), the deceleration determination unit 12 determines to accelerate the motor 3. In addition, when the target operation amount Mtg is equal to the operation amount Md (Mtg−Md), the deceleration determination unit 12 determines not to decelerate the motor 3.

The reference point setting unit 13 is a functional unit for setting the reference points Mth1 to Mth(n) serving as references for switching the change rate Rv within the operation amount adjustment range Wm when the deceleration determination unit 12 determines to decelerate the motor 3. The change rate setting unit 14 is a functional unit for dividing the operation amount adjustment range Wm into the plurality of sections S1 to S(n+1) with reference points Mth 1 to Mth (n) as boundaries, and sets the change rate Rv for each of the sections S1 to S(n+1).

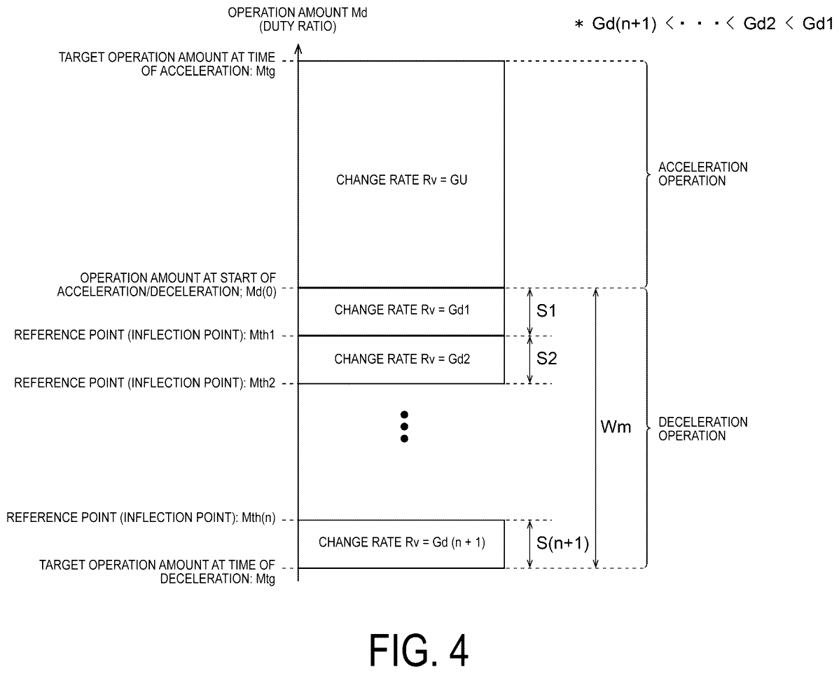

FIG. 4 is a diagram for describing a method of setting the change rate Rv of the operation amount by the motor drive control device 2 according to the embodiment.

When the deceleration determination unit 12 determines to decelerate the motor 3 according to a change in the target operation amount Mtg, the reference point setting unit 13 acquires the operation amount Md(0) before the target operation amount Mtg is changed and the target operation amount Mtg after change from the storage unit 16. The reference point setting unit 13 calculates the operation amount adjustment range Wm based on the acquired operation amount Md(0) and the target operation amount Mtg. For example, the reference point setting unit 13 set the difference between the operation amount Md(0) and the target operation amount Mtg as the operation amount adjustment range Wm.

Next, the reference point setting unit 13 determines the reference points Mth1 to Mth(n) based on the reference point calculation condition 20 stored at the storage unit 16. Here, the reference point calculation condition 20 is information specifying a ratio of dividing the operation amount adjustment range Wm, and is stored at the storage unit 16 in advance. The reference point calculation condition 20 may be rewritable by an external device of the motor drive control device 2.

The reference point setting unit 13 sets points, as the reference points Mth1 to Mth(n), for dividing the operation amount adjustment range Wm at a ratio specified by the reference point calculation condition 20. For example, as illustrated in FIG. 4, when the reference point calculation condition 20 specifying equal division of the operation amount adjustment range Wm into (n+1) is set at the storage unit 16, the reference point setting unit 13 sets the reference points Mth1 to Mth(n) respectively for small ranges obtained by dividing the operation amount adjustment range Wm by (n+1). That is, a value obtained by adding a value obtained by dividing the operation amount adjustment range Wm by (n+1) to the operation amount Md(0) is set as the reference point Mth1, and a value obtained by adding a value (Wm×n/(n+1)) obtained by dividing the operation amount adjustment range Wm by (n+1) and multiplying “n” to the operation amount Md(0) is set as the reference point Mth(n).

For example, when the operation amount adjustment range Wm is equally divided into two parts (n=1), a value obtained by adding a value obtained by dividing the operation amount adjustment range Wm by “2” to the operation amount Md(0) is set as the reference point Mth1. As a result, one reference point Mth1 is set within the operation amount adjustment range Wm, and the operation amount adjustment range Wm is divided into two sections S2 and S1 with the reference point Mth1 as a boundary. In addition, for example, when the operation amount adjustment range Wm is equally divided into three parts (n=2), a value obtained by adding a value obtained by dividing the operation amount adjustment range Wm by “3” to the operation amount Md(0) is set as the reference point Mth1, and a value obtained by adding a value obtained by dividing the operation amount adjustment range Wm by “3” and doubling the division result to the operation amount Md(0) is set as the reference point Mth2. As a result, two reference points Mth1 and Mth2 are set within the operation amount adjustment range Wm, and the operation amount adjustment range Wm is divided into three sections S1, S2, and S3 with the reference points Mth1 and Mth2 as boundaries.

In the following description, when the reference points Mth1 to Mth(n) are not distinguished from each other, the reference points Mth1 to Mth(n) are also referred to as “reference points Mth” when collectively referred to.

Here, the method of setting the sections S1 to S(n+1) is not limited to the above-described method of equally dividing the operation amount adjustment range Wm. For example, the operation amount adjustment range Wm may be divided into the plurality of sections S1 to S(n+1) by dividing the operation amount adjustment range Wm at ratios different from each other.

For example, as shown in FIG. 3, when the reference point calculation condition 20 specifying dividing of the operation amount adjustment range Wm into 2:1 with reference to the operation amount Md(0) s set at the storage unit 16, the reference point setting unit 13 may divide the operation amount adjustment range Wm into two sections S1 and S2 by setting a value obtained by adding a value obtained by multiplying the operation amount adjustment range Wm by “⅔” to the operation amount Md(0) as the reference point Mth1. Alternatively, when the reference point calculation condition 20 specifying dividing of the operation amount adjustment range Wm into 1:2 with reference to the operation amount Md(0) is set at the storage unit 16, the reference point setting unit 13 may divide the operation amount adjustment range Wm into two sections S1 and S2 by setting a value obtained by adding a value obtained by multiplying the operation amount adjustment range Wm by “⅓” to the operation amount Md(0) as the reference point Mth1.

The change rate setting unit 14 sets the change rate Rv for each of the sections S1 to Sn based on a plurality of values Gd1 to Gd(n+1) stored at the storage unit 16, different from each other, and settable as the change rates Rv so as to set the change rate Rv to be smaller as the sections SI to Sn are closer to the target operation amount Mtg. For example, when Gd(n+1)<Gd(n)< . . . <Gd2<Gd1, the change rate setting unit 14 sets the change rate Rv of the section SI to “Gd1”, sets the change rate Rv of the section S2 to “Gd2”, sets the change rate Rv of the section S(n) to “Gd(n)”, and sets the change rate Rv of the section S(n+1) to “Gd(n+1)”. For example, in the example of FIG. 3, the change rate setting unit 14 sets the change rate Rv of the section SI to “Gd1” and sets the change rate Rv of the section S2 to “Gd2” smaller than “Gd1”.

The operation amount calculation unit 15 specifies the sections S1 to Sn with the immediately preceding operation amount Md belonging to the sections S1 to Sn, and changes the operation amount Md to the target operation amount Mtg based on the change rate Rv set for the specified sections S1 to Sn. In the case of the example of FIG. 3, the operation amount calculation unit 15 decreases the operation amount Md at the change rate Rv=Gd1 when the operation amount Md is at the section S1, and decreases the operation amount Md at the change rate Rv=Gd2 smaller than the change rate Rv=Gd1 when the operation amount Md is at the section S2. When the operation amount Md reaches the target operation amount Mtg, the operation amount calculation unit 15 fixes the operation amount Md to the target operation amount Mtg until the target operation amount Mtg is changed.

When the deceleration determination unit 12 determines to accelerate the motor 3 according to a change in the target operation amount Mtg, the change rate setting unit 14 sets the change rate Rv to “Gu” based on s value Gu stored at the storage unit 16, for example. That is, at a time of acceleration of the motor 3, the change rate Rv is a constant value (=Gu).

Next, a sequence of the method of setting the change rate Rv of the operation amount by the motor drive control device 2 according to the embodiment will be described.

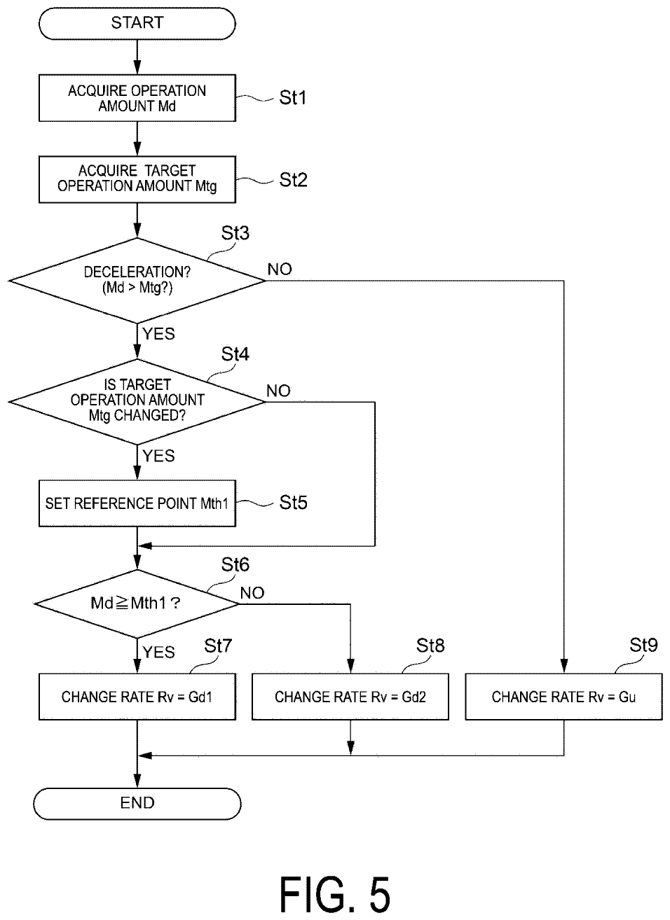

FIG. 5 is a flowchart illustrating a sequence of processing for the method of setting the change rate Rv of the operation amount by the motor drive control device 2 according to the embodiment. In the following description, as an example, as shown in FIG. 3, one reference point Mth1 is set within the operation amount adjustment range Wm, and the operation amount adjustment range Wm is divided into two sections S1 and S2.

First, in the motor drive control device 2, the control circuit 5 acquires the value of the operation amount Md at that time and stores the value at the storage unit 16 (step St1). In addition, the target operation amount calculation unit 11 of the control circuit 5 calculates the value of the target operation amount Mtg corresponding to the target rotation speed specified by the drive command signal Sc by the above-described method, and stores the value at the storage unit 16 (step St2).

Next, the deceleration determination unit 12 of the control circuit 5 determines whether to decelerate the motor 3 (step St3). Specifically, the deceleration determination unit 12 determines whether to decelerate the motor 3 by the above-described method based on the value of the operation amount Md acquired in step St1 and the value of the target operation amount Mtg acquired in step St2. If not decelerating the motor 3 or accelerating the motor 3 (step St3: NO), then the change rate setting unit 14 fixes the change rate Rv to “Gu” (step St9).

On the other hand, if decelerating the motor 3 (step St3: YES), then the control circuit 5 determines whether the target operation amount Mtg has been changed (step St4). If the target operation amount Mtg is changed (step St4: YES), then the reference point setting unit 13 sets the reference point Mth1 within the operation amount adjustment range Wm by the above-described method (step St5).

After the reference point Mth1 is set or when the target operation amount Mtg is not changed in step St4, the operation amount calculation unit 15 specifies the sections S1 and S2, the operation amount Md acquired in step St1 belonging to the sections S1 and S2 (step St6). Specifically, the operation amount calculation unit 15 determines whether the operation amount Md is equal to or greater than the reference point Mth1.

If the operation amount Md is equal to or greater than the reference point Mth1 (step St6: YES), then the operation amount Md is at the section S1, and thus the change rate setting unit 14 sets the change rate Rv to “Gd1” (step St7). On the other hand, if the operation amount Md is equal to or smaller than the reference point Mth1 (step St6: NO), then the operation amount Md is at the section S2, and thus the change rate setting unit 14 sets the change rate Rv to “Gd2” (step St8). By the above-described processing procedure, the control circuit 5 sets the change rate Rv of the operation amount of the motor 3.

Next, effects due to the motor drive control device 2 according to the embodiment will be described.

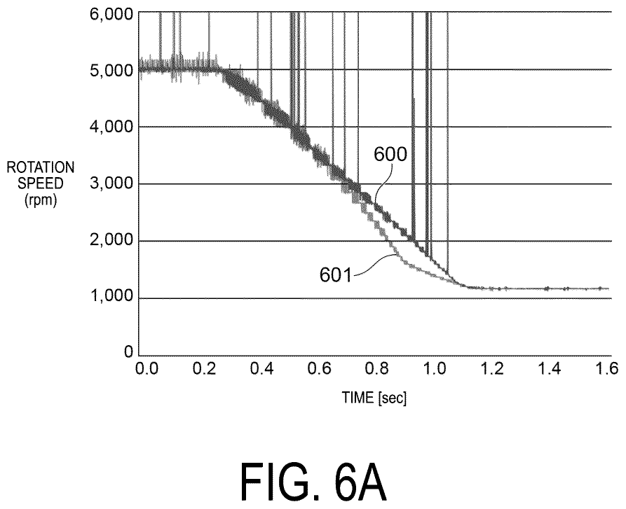

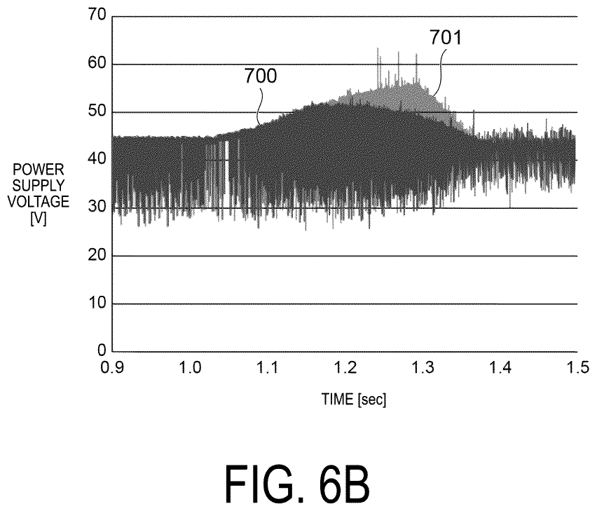

FIG. 6A is a diagram showing a temporal change of a rotation speed at the time of deceleration of the motor 3 in the motor unit 1 according to the embodiment.

FIG. 6B is a diagram showing a temporal change of the power supply voltage at the time of deceleration of the motor 3 in the motor unit 1 according to the embodiment.

In FIG. 6A, the horizontal axis represents time [sec], and the vertical axis represents the rotation speed [rpm] of the motor 3. In FIG. 6A a simulation result of a temporal change of the rotation speed when the motor 3 rotating in the 5000 rpm is decelerated to the 1200 rpm. Specifically, reference numeral 600 represents a simulation result of the rotation speed of the motor 3 with respect to time when the motor 3 is decelerated in the case where the operation amount adjustment range Wm is divided into two sections and the change rate Rv of the operation amount is reduced stepwise as shown in FIG. 3 in the motor drive control device 2 according to a first embodiment. Reference numeral 601 represents a simulation result of the rotation speed of the motor 3 with respect to time when the motor 3 is decelerated in a case where the change rate Rv of the operation amount of the motor 3 is fixed to a greater value (>Gd1)(Rv=constant) as a comparative example.

In FIG. 6B, the horizontal axis represents time [sec], and the vertical axis represents a voltage [V]. In FIG. 6B, a simulation result of a temporal change of the voltage (power supply voltage) of the power supply line supplying a power to the drive circuit 6 (inverter circuit) when the motor 3 rotating in 5000 rpm is decelerated to 1200 rpm. Specifically, reference numeral 700 represents a simulation result of the power supply voltage with respect to time when the motor 3 is decelerated in the case where the operation amount adjustment range Wm is divided into two sections and the change rate Rv of the operation amount is reduced stepwise as shown in FIG. 3 in the motor drive control device 2 according to a first embodiment. Reference numeral 701 represents a simulation result of the power supply voltage with respect to time when the motor 3 is decelerated in a case where the change rate Rv of the operation amount of the motor 3 is fixed to a great value (>Gd1)(Rv=constant) as the comparative example.

As understood from the reference numerals 601 and 701, when the change rate Rv of the operation amount of the motor is fixed to the great value and the motor is decelerated, a speed for the rotation speed of the motor to approach the target rotation speed increases, but the power supply voltage greatly increases. As a result, the operation of the motor drive control device becomes unstable, and it takes time for the rotation speed to reach the target rotation speed. In addition, an electronic component may be broken due to a significant increase in the power supply voltage, and thus it is necessary to select an electronic component having a high withstand voltage.

On the other hand, as understood from the reference numerals 600 and 700, when the operation amount adjustment range Wm is divided into two sections and the change rate Rv of the operation amount is decreased stepwise, an increase in the power supply voltage is suppressed. Thus, the operation of the motor drive control device is stabilized, and as a result, the time until the rotation speed reaches the target rotation speed is substantially equal to the time required when the change rate Rv of the operation amount of the motor is fixed to the great value and the motor is decelerated.

As described above, according to the motor drive control device 2 of the embodiment, when decelerating the motor 3, the change rate Rv of the operation amount of the motor 3 is set to be smaller the closer the operation amount Md to the target operation amount Mtg. Thus, it is possible to improve a speed response while suppressing an increase in the power supply voltage at the time of deceleration of the motor.

In the motor drive control device 2, when decelerating the motor 3 according to a change in the target rotation speed, the control circuit 5 divides the operation amount adjustment range Wm from the operation amount Md(0) before the target operation amount Mtg is changed to the target operation amount Mtg after change into the plurality of sections S1 to S(n+1), and assigns change rates Rv different from each other respectively to the sections S1 to S(n+1) such that the change rate Rv is smaller the closer the sections S1 to S(n +1) to the target operation amount Mtg. According to this, the operation amount adjustment range Wm is divided into the appropriate sections S1 to S(n+1) in accordance with the operation state of the motor 3 when the deceleration operation is started, and then the change rate Rv is assigned to each of the sections S1 to S(n+1). Thus, it is possible to achieve more stable deceleration operation of the motor.

In addition, in the motor drive control device 2, the control circuit 5 may divide the operation amount adjustment range Wm into the plurality of sections S1 to S(n+1) by equally dividing the operation amount adjustment range Wm. For example, as in the above-described example, the operation amount adjustment range Wm may be equally divided into two sections S1 and S2, or the operation amount adjustment range Wm may be equally divided into three sections S1, S2, and S3. According to this, the calculation for setting the sections S1 to S(n+1) is simplified, and thus it is possible to reduce a calculation load by the processor.

In addition, in the motor drive control device 2, the control circuit 5 may divide the operation amount adjustment range Wm into the plurality of sections S1 to S(n+1) by dividing the operation amount adjustment range Wm at ratios different from each other (see FIG. 3). According to this, by appropriately setting the ratios, it is possible to effectively suppress an increase in the power supply voltage while improving the speed response.

In the motor drive control device 2, when it is determined to decelerate the motor 3, the control circuit 5 sets a reference point Mth within the operation amount adjustment range Wm, and divides the operation amount adjustment range Wm into the plurality of sections S1 to S(n+1) with the reference point Mth as a boundary. According to this, it is easy to divide the operation amount adjustment range Wm into the appropriate sections S1 to S(n+1) in accordance with the operation state of the motor 3 when the deceleration operation is performed.

In addition, in the motor drive control device 2, the control circuit 5 sets a point, as the reference point Mth, for dividing the operation amount adjustment range Wm at a ratio specified by the reference point calculation condition 20. According to this it easy to calculate the reference point Mth. In addition, it is possible to set the reference point Mth at any position by appropriately changing the reference point calculation condition 20.

### Expansion of Embodiments

The invention made by the present inventor has been specifically described above based on the embodiments, but the present invention is not limited to the embodiments, and it goes without saying that the present invention can be changed in various ways within the scope not departing from the gist of the present invention.

For example, in the present embodiment, the motor 3 is not limited to the three-phase brushless DC motor, and may be, for example, a single-phase brushless DC motor. In addition, the motor 3 is not limited to the brushless DC motor, and may be, for example, another type of a motor.

Although a case is illustrated, in the case, each functional unit of the control circuit 5 is achieved by program processing of the MCU, a part or all of each functional unit of the control circuit 5 may be achieved by a dedicated circuit (hardware).

In addition, the flowchart described above is an example and is not limited to this example. For example, other processing may be inserted between each step or processing may be parallelized.

### REFERENCE SIGNS LIST

1 Motor unit, 2 Motor drive control device, 3 Motor, 4 Rotor blade (propeller), 5 Control circuit, 6 Drive circuit, 11 Target operation amount calculation unit, 12 Deceleration determination unit, 13 Reference point setting unit, 14 Change rate setting unit, 15 Operation amount calculation unit, 16 Storage unit, 17 Drive control signal generation unit, 20 Reference point calculation condition. Md Operation amount, Mtg Target operation amount. Mth, Mth1 to Mth(n) Reference point, Rv Change rate, S1 to S(n+1) Section, Sc Drive command signal (speed command signal), Sd Drive control signal, Wm Operation amount adjustment range, Md(0) Operation amount before target operation amount is changed (operation amount at start of acceleration/deceleration), Gd1 to Gd(n+1) Value settable as change rate.

1. A motor drive control device comprising:
a drive circuit configured to drive a motor based on a drive control signal configured to control driving of the motor; and
a control circuit configured to calculate an operation amount of the motor to rotate the motor at the target rotation speed based on a drive command signal specifying a target rotation speed of the motor, and generate and output the drive control signal in accordance with the operation amount, wherein
the control circuit sets a change rate of the operation amount to be smaller the closer the operation amount to a target operation amount corresponding to the target rotation speed when decelerating the motor according to a change in the target rotation speed, and
the control circuit changes the operation amount in accordance with the change rate such that the operation amount coincides with the target operation amount after change when decelerating the motor according to a change in the target rotation speed.

2. The motor drive control device according to claim 1, wherein
when decelerating the motor according to a change in the target rotation speed, the control circuit divides an operation amount adjustment range into a plurality of sections, the operation amount adjustment range being a range from the operation amount before the target operation amount is changed to the target operation amount after change, and assigns a plurality of the change rates different from each other respectively to the sections such that the change rate is smaller the closer the sections to the target operation amount.

3. The motor drive control device according to claim 2, wherein
the control circuit divides the operation amount adjustment range into the plurality of sections by equally dividing the operation amount adjustment range.

4. The motor drive control device according to claim 2, wherein
the control circuit divides the operation amount adjustment range into the plurality of sections by dividing the operation amount adjustment range at ratios different from each other.

5. The motor drive control device according to claim 2, wherein
the control circuit includes
a target operation amount calculation unit configured to calculate the target operation amount based on the drive command signal,
an operation amount calculation unit configured to calculate the operation amount by changing the operation amount in accordance with the change rate to reach the target operation amount,
a drive control signal generation unit configured to generate a PWM signal having a duty ratio corresponding to the operation amount and output the PWM signal as the drive control signal,
a deceleration determination unit configured to determine whether to decelerate the motor based on a difference between the target operation amount and the operation amount when the target operation amount is changed,
a reference point setting unit configured to set a reference point within the operation amount adjustment range when the deceleration determination unit determines to decelerate the motor,
a storage unit configured to store change rate information including a plurality of values different from each other and settable as the plurality of change rates, and
a change rate setting unit configured to divide the operation amount adjustment range into the plurality of sections with the reference point as a boundary and set the change rate for each of the sections, wherein
the change rate setting unit sets the change rate for each of the sections such that the change rate is smaller the closer the section to the target operation amount based on the change rate information, and
the operation amount calculation unit configured to specify the section with an immediately preceding operation amount belonging to the section specified, and change the operation amount to the target operation amount based on the change rate set in the specified section.

6. The motor drive control device according to claim 5, wherein
the storage unit stores a reference point calculation condition specifying a ratio of dividing the operation amount adjustment range, and
the reference point setting unit sets a point, as the reference point, dividing the operation amount adjustment range at a ratio specified by the reference point calculation condition.

7. A motor unit comprising:
the motor drive control device according to claim 1; and
the motor.

8. A motor drive control method comprising:
calculating an operation amount of a motor to rotate the motor at a target rotation speed; and
generating a drive control signal in accordance with the operation amount calculated in the calculating to drive the motor, wherein
the calculating includes
setting a change rate of the operation amount to be smaller the closer the operation amount to a target operation amount corresponding to the target rotation speed when decelerating the motor according to a change in the target rotation speed, and
changing the operation amount based on the change rate and the operation amount coincides with the target operation amount after change when decelerating the motor according to a change in the target rotation speed.
